(19) United States
(12) Patent Application Publication
(10) Pub. No.: US 2023/0278488 A1
(43) Pub. Date: Sep. 7, 2023

(54) Device and Method for Locating a Parked Vehicle

(71) Applicants: Jill Lenore Morgan, Spring Lake, NJ (US); Dylan Leone McKelvia, Spring Lake, NJ (US)

(72) Inventors: Jill Lenore Morgan, Spring Lake, NJ (US); Dylan Leone McKelvia, Spring Lake, NJ (US)

(21) Appl. No.: 18/054,182

(22) Filed: Nov. 10, 2022

Related U.S. Application Data
(60) Provisional application No. 63/315,567, filed on Mar. 2, 2022.

(51) Int. Cl. B60Q 1/48; B60Q 1/26

(52) U.S. Cl. CPC B60Q 1/482; B60Q 1/2696

(57) ABSTRACT

The present invention relates to a vehicle locating device that enables vehicle owners to locate their vehicles quickly and easily in a large or crowded parking area. The device features an indicator portion having a basic shape such as a hand, circle, triangle, star, crescent moon and more in a neon color having an integrally attached elongated stem. In use, the stem is secured between the vehicle's car door and vehicle body, between the trunk and vehicle body, or between the window and door window frame, wherein the indicator portion is extended in the air above or away from the vehicle for ease of visually locating a vehicle. In some embodiments, the device is attached to an inner surface of the roof of the vehicle and has a plurality of LEDs disposed therein. The device saves an individual time and reduces the stress often associated with searching for one's vehicle.

### CROSS-REFERENCE TO RELATED APPLICATION

The present application claims priority to, and the benefit of, U.S. Provisional Application No. 63/315,567, which was filed on Mar. 2, 2022, and is incorporated herein by reference in its entirety.

### FIELD OF THE INVENTION

The present invention relates generally to the field of parked vehicles. More specifically, the present invention relates to a novel device and associated method for easily locating a vehicle parked in a large parking area or large parking garage. The apparatus has basic shapes such as a hand, circle, square, triangle, star, and more in a neon color which is attached to a stem and secured to a vehicle's car door or trunk area and can be extended outside the vehicle for ease of visually locating the vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, malls, airports, theaters, and other large venues often feature large parking garages, tiered parking structures, and/or large parking areas/lots. Losing a vehicle is particularly easy in such large venues and finding a misplaced vehicle is particularly challenging. It is common for drivers and vehicle owners to experience difficulty in locating a vehicle that they previously parked in a parking structure. Individuals often wander around for prolonged periods of time searching for their vehicle. Surveys have revealed that generally about one in seven drivers (i.e., 14%) forget where they parked their vehicles and end up spending a lot of time and considerable effort in searching for their vehicles.

Many vehicles look alike and are of the same manufacturer and color and as a result, cause confusion in identifying the correct vehicle by individuals. License plates are not readily visible from a distance and as a result, individuals end up walking up to vehicles that look like their own vehicle.

Often, in order to avoid misplacing their vehicle in a parking area, lot, or garage, individuals take a photo of the floor name and parking spot number. These manual methods are ineffective, and individuals often forget to take the photograph or note the parking spot number. Often, conventional GPS or internet-based vehicle detection does not work in underground parking areas due to unavailability of cellular or data network.

Elderly individuals find it difficult to use complex and remotely controlled devices for finding vehicles. Further, electronic devices used for indicating a vehicle's presence may require regular maintenance and are expensive. Individuals desire a simple, cost-effective, and efficient device for finding their vehicles in parking areas or similar venues.

Therefore, there exists a long-felt need in the art for a device that easily and effectively locates a parked vehicle in any parking venue. There is also a long-felt need in the art for an easy-to-use vehicle identification device that enables car owners to locate their vehicle quickly and easily in a large or crowded parking area. Additionally, there is a long-felt need in the art for a vehicle locating device that does not depend on any type of network for functionality. Moreover, there is a long-felt need in the art for a device that can be easily and detachably attached to a vehicle for enabling a user to search for his or her vehicle from a long distance. Further, there is a long-felt need in the art for a vehicle locating device that is easy to use and weather resistant. Furthermore, there is a long-felt need in the art for a device that helps users in locating their vehicle and that is vehicle-agnostic. Finally, there is a long-felt need in the art for a unique vehicle locating device that saves an individual time and reduces the stress often associated with searching for one's vehicle.

The subject matter disclosed and claimed herein, in one embodiment thereof, comprises a vehicle locating device for enabling vehicle owners to locate their vehicle quickly and easily in a large or crowded parking area without the use of any electronic or remote device. The device further comprises an indicator portion for indicating the location of a vehicle, a stem integrally attached and extending from the indicator portion, wherein the stem is positioned inside the vehicle and supported by a closed door of the vehicle such that the indicator portion extends out of the vehicle to be used as an identifying and locating means for the vehicle. In some embodiments, the device is manually placed and secured to the door by a user and in other embodiments, the device is attached to the inner surface of the roof of the vehicle and can be operated by a control button positioned inside the vehicle.

In this manner, the novel vehicle locating device of the present invention accomplishes all of the foregoing objectives and provides a device that obviates the need for a user to remember the vehicle location or clicking a picture of the parking location. Further, the device is easy-to-use, cost effective and eliminates the need for users to spend considerable time trying to find a vehicle parked in a parking structure. The device is mechanical, weather resistant, and does not depend on any type of communication network to enable its operation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle locating device for enabling vehicle owners to locate their vehicle quickly and easily in a large or crowded parking area without the use of any electronic or remote device. The device further comprises an indicator portion for indicating the location of a vehicle, a stem integrally attached and extending from the indicator portion, wherein a portion of the stem is positioned inside the vehicle and supported by a closed door of the vehicle such that the indicator portion extends out of the vehicle which can then be used as an identifying and locating means for the vehicle.

In yet another embodiment, a device for locating a vehicle in a parking venue is disclosed. The device is designed to secure to the vehicle's car door and/or trunk area and is extended outside the exterior of the vehicle for ease of visually locating the vehicle. The device features a basic shape, such as of a hand with unfolded fingers, a triangle, a star, a crescent moon, and the like; and, a stem portion, the stem portion remains partially inside the vehicle and the basic shape extends out of the vehicle such that the stem is supported by the closed door and trunk.

In yet another embodiment, an apparatus for locating a vehicle from a long distance is disclosed. The apparatus features a basic shape, such as of a hand with unfolded fingers, a triangle, a star, a crescent moon, and the like, and a pivotable stem portion, and the stem portion is detachably attached to an inner surface of a roof of the vehicle. A control button is positioned on the inner surface of the roof and is configured to extend the basic shape indicator portion outside of the vehicle through a door or window of the vehicle.

In yet another embodiment, the basic shape has a plurality of LEDs that are illuminated upon activation of a second control button positioned inside the vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle locating apparatus of the present invention in accordance with the disclosed architecture;

FIG. 2 illustrates a perspective view of a vehicle equipped with the vehicle locating apparatus of FIG. 1 in accordance with the disclosed architecture;

FIG. 3 illustrates a perspective view showing another embodiment of the vehicle locating device of the present invention in accordance with the disclosed architecture;

FIG. 4 illustrates a flow diagram depicting one process of using the vehicle identification apparatus of the present invention in accordance with the disclosed architecture;

FIG. 5 illustrates a flow diagram depicting another process of using the vehicle locating device of one embodiment of the present invention in accordance with the disclosed architecture; and

FIG. 6 illustrates a perspective view showing different embodiments of the vehicle locating device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that easily and effectively locates a parked vehicle in any parking venue. There is also a long-felt need in the art for an easy-to-use vehicle identification device that enables car owners to locate their vehicle quickly and easily in a large or crowded parking area. Additionally, there is a long-felt need in the art for a vehicle locating device that does not depend on any type of wireless or communication network for functionality. Moreover, there is a long-felt need in the art for a device that can be easily and detachably attached to a vehicle for enabling a user to search for his or her vehicle from a long distance. Further, there is a long-felt need in the art for a vehicle locating device that is easy to use and weather resistant. Furthermore, there is a long-felt need in the art for a device that helps users in locating their vehicle and that is vehicle-agnostic. Finally, there is a long-felt need in the art for a unique vehicle locating device that saves an individual time and reduces the stress often associated with searching for one's vehicle.

The present invention, in one exemplary embodiment, is an apparatus for locating a vehicle from a long distance. The apparatus features a basic shape, such as of a hand with unfolded fingers, a triangle, a star, a crescent moon, and the like, and a pivotable stem portion, and the stem portion is detachably attached to inner surface of roof of the vehicle. A control button is positioned on the inner surface of the roof and is configured to extend the basic shape indicator portion outside of the vehicle through a door or window of the vehicle. The apparatus is preferably of neon color and is made of weatherproof flexible rubber or plastic, or bendable metal.

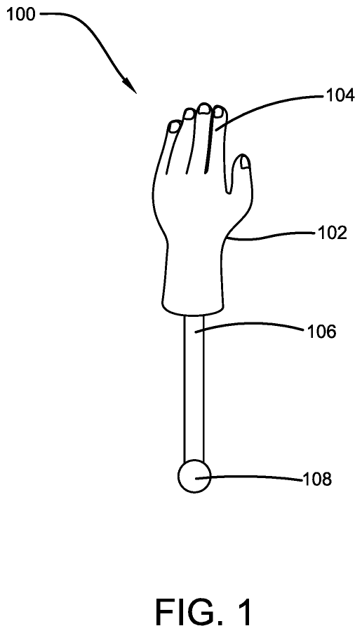

Referring initially to the drawings, FIG. 1 illustrates a perspective view of one potential embodiment of vehicle locating apparatus of the present invention in accordance with the disclosed architecture. The vehicle locating apparatus 100 of the present invention is designed to selectively attach and detach to a vehicle thereby enabling a vehicle owner to locate their vehicle quickly and easily in a large or crowded parking area. The indicator is flexible to withstand any physical damage or strong wind and is made of weather resistant rubber or plastic material, thus, resisting damage in inclement weather. A bendable and rigid stem portion is used to secure and support the indicator.

In the present embodiment, the device 100 includes an indicator in the shape of a hand 102 with unfolded fingers 104 and has an elongated stem 106. The hand 102 and the fingers 104 form the indicator portion of the device 100. The device 100 has a one-piece structure and is lightweight. The stem 106 is bendable and rigid and remains extended once placed into position. The stem 106 has a length of from about 12″ to about 24″ and can be hollow or solid such that the bottom end 108 is positioned inside the vehicle and a small portion of the stem 106 is held in a desired place between, for example, a window and a window frame of a door of the vehicle. In one exemplary embodiment, the stem 106 is metal wire from about 8-gauge to about 13-gauge steel wire. In another exemplary embodiment, the stem 106 is metal wire from about 9-gauge to about 11-gauge steel wire. In this manner, the hand 102, fingers 104, and a majority of the stem 106 is positioned in an appropriate position, such as extending vertically above the roof of a vehicle in order to easily spot the indicator and identify the vehicle from a distance. In other mounting positions, the stem 106 can be secured between the vehicle door window frame and a vehicle body panel (i.e., a pillar of the vehicle), between the vehicle door window frame and a roof panel of the vehicle, or between a door window and the vehicle door window frame.

The device 100 has a neon color and the rubber or plastic material can contain tiny glass beads embedded in the device 100 that reflect light back to the source. The device 100 is also tear and scratch resistant and may come in a variety of colors and designs.

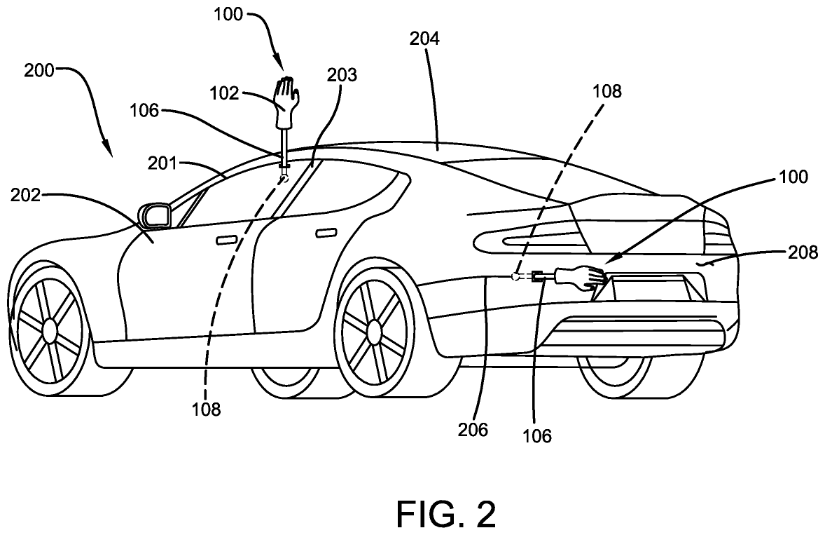

FIG. 2 illustrates a perspective view of a vehicle equipped with the vehicle locating apparatus of FIG. 1 in accordance with the disclosed architecture. The vehicle 200 can be any type of vehicle, for example, a car, a truck, or an SUV, and can be gas, hybrid, or electric powered, or the like. More specifically, in the present embodiment, the stem 106 of the vehicle locating device 100 is manually held in place between a window frame 201 of a door 202 and a pillar 203 of the vehicle 200 such that the hand portion 102 and a majority of the stem portion 106 are positioned outside the door 202. A minority of the stem portion 106 and the bottom end 108 (not illustrated) are positioned inside the door 202. The device 100 is positioned in a way such that the hand portion 102 and a majority of the stem portion 106 remain in an upright orientation above the roof 204 of the vehicle 200, thereby enabling a car owner to locate the vehicle 200 easily even from a long distance.

Similarly, the device 100 can be positioned with the stem 106 extending through a seam 206 between a closed trunk and the vehicle body such that the device 100 may extend generally horizontally outward and rearward away from the exterior surface 208 of the vehicle. Alternatively, the device 100 can be removably positioned on an exterior surface 208 of the trunk 206.

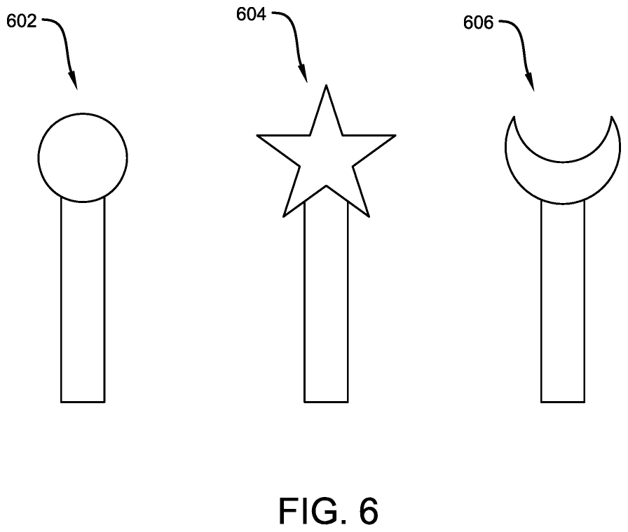

Another vehicle indicator having another shape (refer to FIG. 6), such as, for example, an illuminating or reflective triangle, circle, star, or crescent moon, can be detachably attached to another portion of the vehicle. Similar to the device 100, the indicator can be secured with the stem extending through a seam between a closed door, window, and the like, and the vehicle body.

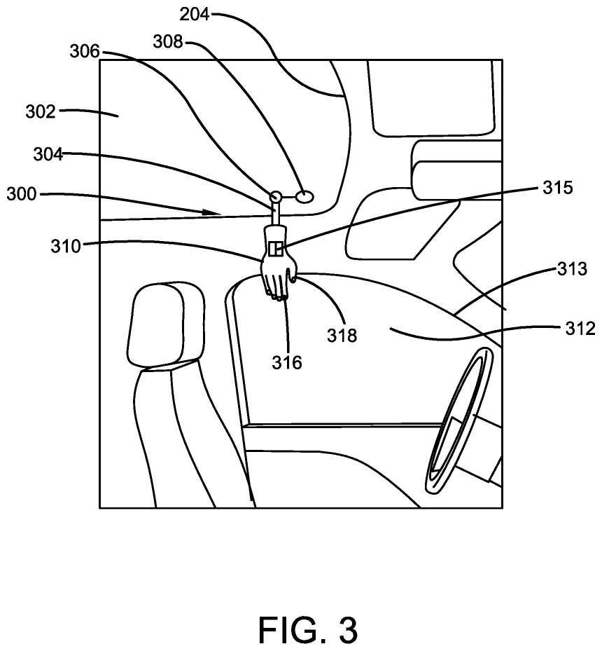

FIG. 3 illustrates a perspective view showing another embodiment of the vehicle locating device of the present invention in accordance with the disclosed architecture. In the present embodiment, the device 300 is attached to the inner surface 302 of the roof 204 of the vehicle 200. The stem 304 is detachably attached to the inner surface 302 and is pivotable along the pivoting point 306. A first control button 308 is positioned on the surface 302 in the vicinity of the device 300 and is configured to release and move the hand portion 310 of the device 300 out of the window 312 of the vehicle 200 such that the stem 304 can be passed between the window 312 and the window frame 313, wherein, when mounted, a majority of the stem 304 and the hand portion 310 remain outside of the car 200 when the car window 312 is closed (not illustrated). The stem 304 is bendable and rigid and remains extended even when the window 312 or the door 202 of the vehicle 200 is closed.

The hand portion 310 can include a solar panel 315 to power and charge a battery for illuminating a plurality of LEDs 316 positioned on the finger portions 318 of the device 300. The LEDs 316 are weatherproof and help a car owner locate the vehicle even in dark areas by illuminating the finger portions 318. The solar panels 315 absorb light during the daytime hours and automatically supply power to a battery (not illustrated) for illuminating the LEDs 316 during the nighttime hours. The battery is a rechargeable battery and can be a lithium-ion battery, a nickel cadmium (NiCd) battery, or a nickel metal hydride (NiMH) rechargeable battery. When a charge is applied, in the case of the solar lights via the sun, lithium ions, for example, move from one side of the battery (the cathode) to the other to a material, usually graphite (the anode), where they are stored. This is now a ‘charged’ battery. When nighttime falls, a light sensor tells the solar light to switch on. The lithium ions then move back from the graphite layer where they were stored back to the cathode. This energy is then converted from electrical energy into light energy and the LEDs are then illuminated. This is particularly advantageous when a vehicle is parked during the day and returned to at night, for example, when attending a concert or sporting event. When not in use, the first control button 308 is used for returning the device 300 to a rest position wherein the device 300 adheres to the inner surface 302 for secure storage.

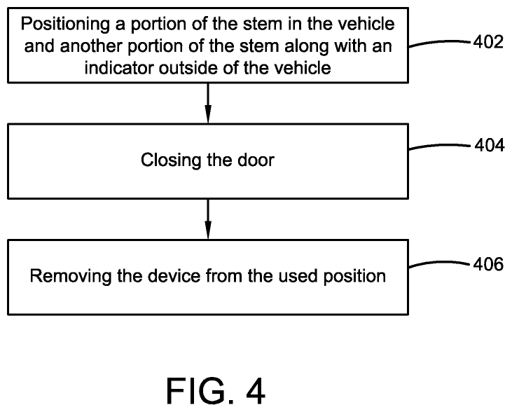

FIG. 4 illustrates a flow diagram depicting one process of using the vehicle identification apparatus of the present invention in accordance with the disclosed architecture. Initially, a user positions the vehicle locating device by a door and/or trunk of a vehicle such that a portion of the stem of the device is inside the vehicle, and another portion of the stem and the indicator part is positioned outside of the vehicle (Step 402). The stem rests along the periphery of the door opening or window opening when positioned by a user. Thereafter, the door of the vehicle is closed, such that the stem is pinned in a vehicle seam and at least the indicator part remains outside the vehicle (Step 404). When the device is not needed for locating the vehicle, the device is removed when the door of the vehicle is opened and is easily stored inside the vehicle (Step 406).

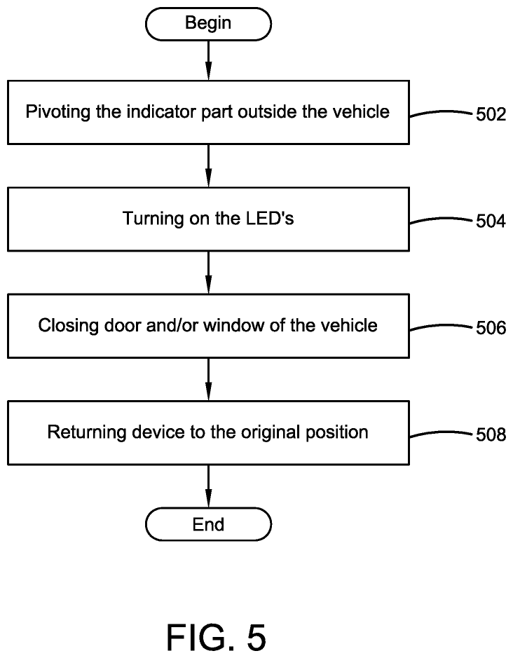

FIG. 5 illustrates a flow diagram depicting another process of using the vehicle locating device of one embodiment of the present invention in accordance with the disclosed architecture. Initially, for using the device for identifying the vehicle in which the device is installed, the device is pivoted to outside the vehicle while the stem remains attached to the inner surface of the roof (Step 502). Then, the LEDs of the device are turned on using a control button (Step 504). Thereafter, the door and the window through which the device extends out of the vehicle, are closed by a user (Step 506). After use of the device, the device is returned to the original position of adhering to the inner surface of the roof (Step 508).

FIG. 6 illustrates a perspective view showing different embodiments of the vehicle locating device of the present invention in accordance with the disclosed architecture. The vehicle locating device of the present invention can be of different shapes, sizes, and designs as per preferences of vehicle owners. As illustrated, the device can be in the form of circle-shaped device 602, star shaped device 604, or crescent moon shaped device 606.

It should be noted that the vehicle locating device of different embodiments of the present invention has a stem that remains inside the vehicle during use for secure and stable positioning of the device. Further, the length and the width of the stem can depend on the design and size of the device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle locating apparatus”, “vehicle locating device”, “apparatus”, “device”, and “vehicle identification device” are interchangeable and refer to the multipurpose vehicle locating apparatus 100, 300, 602, 604, 606 of the present invention.

Notwithstanding the foregoing, the multipurpose vehicle locating apparatus 100, 300, 602, 604, 606 of the present invention can be of any suitable size and configuration as is known in the art without affecting the overall concept of the invention, provided that it accomplishes the above-stated objectives. One of ordinary skill in the art will appreciate that the multipurpose vehicle locating apparatus 100, 300, 602, 604, 606 as shown in the FIGS. are for illustrative purposes only, and that many other sizes and shapes of the multipurpose vehicle locating apparatus 100, 300, 602, 604, 606 are well within the scope of the present disclosure. Although the dimensions of the multipurpose vehicle locating apparatus 100, 300, 602, 604, 606 are important design parameters for user convenience, the multipurpose vehicle locating apparatus 100, 300, 602, 604, 606 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle locating apparatus comprising:
a vehicle locator device having an indicator portion, a stem portion, and a bottom end;
wherein said vehicle locator device selectively attachable to a vehicle;
wherein said stem portion is bendable and rigid;
wherein said indicator portion is a neon color; and
further wherein when said vehicle locator device mounted to the vehicle, a majority of said stem portion and said indicator portion extend on the outside of the vehicle, and a minority of said stem portion and said bottom end retained inside of the vehicle.

2. The vehicle locating apparatus of claim 1, wherein said indicator portion is in the form of a hand and unfolded fingers.

3. The vehicle locating apparatus of claim 2, wherein said indicator portion having a solar panel for recharging a battery and said fingers include a plurality of LEDs, and further wherein said battery powers said plurality of LEDs.

4. The vehicle locating apparatus of claim 3, wherein said stem portion having a length from about 12″ to about 24″.

5. The vehicle locating apparatus of claim 4, wherein said indicator portion comprising a material selected from rubber and a plastic including glass beads embedded therein.

6. The vehicle locating apparatus of claim 5, wherein said stem portion extending in a vertical orientation.

7. The vehicle locating apparatus of claim 2, wherein said stem portion extending in a vertical orientation.

8. The vehicle locating apparatus of claim 7, wherein said indicator portion in a form selected from a shape consisting of a hand and fingers, a circle, a star, and a crescent.

9. The vehicle locating apparatus of claim 8, wherein said stem portion extending in a generally horizontal orientation.

10. The vehicle locating apparatus of claim 1, wherein said stem portion having steel wire including a gauge from about 8 gauge to about 13 gauge.

11. The vehicle location apparatus of claim 1, wherein said stem portion having steel wire including a gauge from about 9 gauge to about 11 gauge.

12. A vehicle locating apparatus comprising:
a vehicle locator device having an indicator portion, a stem portion, and a bottom end;
wherein said vehicle locator device selectively attachable to a vehicle;
wherein said stem portion is bendable and rigid;
wherein when said vehicle locator device mounted to the vehicle, a section of said stem portion and said indicator portion extend on the outside of the vehicle, and another section of said stem portion and said bottom end retained inside of the vehicle;
wherein said indicator portion having a solar panel, a battery, and a plurality of LEDs;
wherein said solar panel recharges said battery; and
further wherein said battery powers said plurality of LEDs.

13. The vehicle locating apparatus of claim 12, wherein said indicator portion is in the form of a hand and unfolded fingers.

14. The vehicle locating apparatus of claim 12, wherein said stem portion having a length from about 12″ to about 24″.

15. The vehicle locating apparatus of claim 12, wherein said indicator portion comprising a material selected from rubber and a plastic including glass beads embedded therein.

16. The vehicle locating apparatus of claim 12, wherein said stem portion extending in a vertical orientation.

17. The vehicle locating apparatus of claim 12, wherein said indicator portion in a form selected from a shape consisting of a hand and fingers, a circle, a star, and a crescent.

18. The vehicle locating apparatus of claim 12, wherein said stem portion extending in a generally horizontal orientation.

19. The vehicle locating apparatus of claim 12, wherein said stem portion having steel wire including a gauge from about 8 gauge to about 13 gauge.

20. A vehicle locating apparatus comprising:
a vehicle locator device having an indicator portion, a stem portion, and a bottom end;
wherein said vehicle locator device selectively attachable to a vehicle;
wherein said stem portion is bendable and rigid;
wherein said stem portion having steel wire including a gauge from about 8 gauge to about 13 gauge;
wherein when said vehicle locator device mounted to the vehicle, a section of said stem portion and said indicator portion extend on the outside of the vehicle, and another section of said stem portion and said bottom end retained inside of the vehicle;
wherein said stem portion mounted between a vehicle door frame and a vehicle body panel; and
further wherein said majority of said stem portion extending in a vertical orientation.
